(19) United States
(12) Patent Application Publication
(10) Pub. No.: US 2011/0295721 A1
(43) Pub. Date: Dec. 1, 2011

(54) USER INFORMATION AND DISTRIBUTION SYSTEM

(75) Inventor: Jonathan MacDonald, Camberley (GB)

(73) Assignee: Apple Inc., Cupertino, CA (US)

(21) Appl. No.: 13/024,562

(22) Filed: Feb. 10, 2011

Related U.S. Application Data
(60) Provisional application No. 61/309,036, filed on Mar. 1, 2010.

(51) Int. Cl. G06F 15/16; G06Q 30/00

(52) U.S. Cl. 705/27.1; 709/206; 705/1.1

(57) ABSTRACT

Method and system for managing personal information about members in a data storage unit and distributing digital communication to the members. The data storage unit is accessible through a member device, such as a mobile phone or PDA, thereby enabling entry of the personal information. At least one part of the member's personal information is associated with a unique identifier that enables tracking of how the personal information is used. The data storage unit provides the member an opportunity to select what personal information can be distributed by the data storage unit and in what manner. Personal information from each member is made available to clients through a client interface via a communication network element. A notification message is sent to the member when the member's personal information is made available to the client and/or utilized by the client to send the digital communication.

### CROSS-REFERENCE TO RELATED APPLICATION

This application claims priority under 35 U.S.C. §119(e) of U.S. provisional patent application Ser. No. 61/309,036 filed Mar. 1, 2010, incorporated by reference in its entirety herein.

### FIELD OF THE INVENTION

The present invention relates generally to a method and system for managing information relating to a user of a telecommunications network, such as a member or participant in a service conducted using the telecommunications network, in a data storage unit, which information may be used for digital communications, including but not limited to direct marketing, to one or more of the users, members or participants.

### BACKGROUND OF THE INVENTION

There is an ever-increasing utilization of personal information to tailor products, services, customized offerings and promotions through digital media by companies and organizations to the individuals based on their personal information. It is further becoming common practice that the companies and organizations, who collect personal information, pass on, sell and/or exchange the information specific to individuals to or with other companies and organizations.

This has lead to high volumes of unwanted or irrelevant digital communications often being sent out to individuals, e.g., through their telecommunications devices. This unwanted or irrelevant information further decreases the actual interaction or active responses from those individuals the companies and organizations are looking to communicate with. Furthermore, it has also lead to an increased risk of identity fraud as individuals' personal information resides with a large number of companies and organizations.

There is also often a large amount of additional analysis of available information and subsequent gathering of complementary information about individuals performed by the companies or organizations in attempts to improve the quality of the digital communication being directed to the individuals from the companies and organizations.

Digital communications for activities, such as advertisements, promotions, market research, and trials, are today mainly done through e-mail, but also increasingly through mobile devices and messaging services. The messaging services include, e.g., SMS (short messaging services), MMS (multimedia message service), data services such as Internet or WAP (wireless application protocol) browsing, video calls, downloading content, streaming content, purchasing applications such as games or other software, whereby personal information of one or more individuals is involved in the messaging. The popularity of mobile devices, such as the G1 from Google, the iPhone from Apple, Smartphones from other handset manufacturers and small laptops, has increased the use of mobile marketing in the form of casting and direct marketing, i.e., advertisements to the users of the mobile devices. As there is an increased amount of personal information relating to the mobile device, e.g., past activities, travel patterns, geographic location, demography, browsing history and others, there is an increased need for improved security and management of the personal information.

Authorities, legislation and consumers often place high demands on the handling, storing and distribution of personal information. For mobile devices for individuals in the European Union (EU), there are strict EU regulations, e.g., DIRECTIVE 2002/58/EC concerning the processing of personal data and the protection of privacy in the electronic communications sector (Directive on privacy and electronic communications), as well as national Data Protection Acts (e.g., DPA 1998 in the UK) in most countries. More and more consumers are becoming aware of their information being passed on and in some cases even sold to other companies and organizations. This leads to individuals not wanting to disclose or share information when answering questions or completing electronic forms on-line or through mobile devices.

U.S. patent application publication No. 2007/0263632 discloses a system and method for mediating information. Information from an information provider terminal unit is stored in a mediation server. The information from the mediation server is disclosed to a user terminal after converting the information into dummy information to prevent the disclosure of unauthorized information. Following the permission from the information provider to disclose the information, the mediation server provides the related information to restore the dummy information. This is a very complicated technical solution and still suffers from the above-mentioned problems of unwanted or irrelevant digital communication being sent out. Furthermore, this approach to improving the security of the provided information offers poor information management and further, does not contribute to a more efficient delivery of digital communications.

International patent application No. PCT/IB2006/050761 discloses an information client system. An agent may assist a target to either directly or indirectly enter information onto a data storage server. A research and direct marketing system may allow for the capture of market information dynamically, while in the field. A confirmation in the system may be an order and/or merchandising confirmation. This information client system still suffers from the same problems described above and does not improve the efficiency and quality of the digital communication delivery.

As there is an ever-increasing amount of digital communication on the Internet and through the Mobile Internet, any small improvement in communication delivery and improved quality of content is of substantial importance to the industry.

### OBJECTS AND SUMMARY OF THE INVENTION

An object of one or more embodiments of the present invention is to improve prior art techniques for providing efficient and relevant digital communications to an individual.

Another objective of one or more embodiments of the present invention is to allow an individual possessing a telecommunications device to electronically control their personal information and benefit when the information is utilized by a third party.

Accordingly, in one embodiment of the present invention, at least one of the foregoing and possibility other objects that will appear from the following description may be achieved by means of a method for managing information from an individual in a data storage unit, wherein information is used for digital communication to one or more of the individuals and the data storage unit is accessible through the individual's device, i.e., an information input device which is often a communications device, allowing entry of personal information. At least one part of the individual's personal information is associated with an unique identifier that allows for tracking how the personal information is used and the data storage unit provides the individual an opportunity to select what personal information is allowed to be distributed by the data storage unit. Then, personal information from one or more of the individuals is made available to a client through a client interface via a communication network element, and a notification message is sent to the individual when the individual's personal information from the data storage unit is made available to the client or utilized by the client to send digital communication.

In another method in accordance with the invention for accessing an individual's information a data storage unit, the personal information from one or more members is made accessed by a client through a client interface and client device to enable the client to search the personal information on a data storage unit to find and select the preferred individuals and request access of the personal information of those selected individuals. A digital communication in the form of a questionnaire or an advertisement is sent to the selected individuals by the client based on the provided personal information.

In a system in accordance with the invention for managing information from an individual in a data storage unit, the system allows the individual to enter their personal information in predefined parameter fields, to update the existing information in the fields and access the overall member profile using a member device. A user interface of the data storage unit enables a client to access available personal information from individuals using a client device, and the data storage unit has a notification message system allowing a message to be sent via a communication network element in the form of, e.g., an SMS, MMS, e-mail, or electronic transfer, to the individual once their personal information is accessed about the provider of a digital communication who is utilizing the personal information. The notification message stores the amount of credits allocated to the individual following the use of the individual's personal information in the data collection unit accessible by the individual.

The inventive method and systems thus generate a higher quality personal information as the server provides individuals with the ability to manage their personal information. Also the individual enters the information themselves and also controls what part of the information that should be shared with a third party. A notification message provides a verification to the individual when a transaction has taken place and/or a client accesses the individual's information. The overall method and system allow for a more efficient solution where digital messages are delivered to the individuals with content that is of relevance and accurate to the individual's current situations, so-called targeted messaging. It also prevents the personal information from being sold multiple times by different vendors or list brokers, decreasing the likelihood of unwanted or irrelevant information being sent to the individual. It also decreases the risk of identity fraud, which is further reduced by the individual controlling what part of their information should be passed on, if any.

Further, another advantage of the present invention is to utilize improved methodology to deliver highly targeted digital communications. Since the individual controls the personal information that the third party uses to send out their advertisements, the relevance of the content is much greater than normal as the third party is looking to interact with the individual and provide value added information. Further, market research shows that more than 70% of mobile users are willing to receive targeted messages if the content is highly relevant to them. This of course increases substantially by having individuals and content of the advertisements tailored based on the information provided by the individuals themselves. This allows for a higher quality experience for the recipient of the digital communication, as it is relevant and expected.

In an alternative embodiment of the method and system of the present invention, the individual has a feedback option in addition to information parameters provided earlier to indicate when a suitable time, such as date, time of day, etc., is provided to the data storage unit or client for reception of communications. This feature would allow for overseas travel or holiday plans to be provided before the digital communication is sent out. By providing highly relevant and timely information, such as the individual's suitable delivery date and time or what type of mobile device the individual has for a give time, the load on the cellular network decreases and the communication delivery success increases multiple times over. In one case, the delivery rate of a digital communication increased eight-fold when delivery time was tailored to the individual and recent activities or usage of their mobile device.

In another embodiment of the method and system of the present invention, the individual's personal information is tagged and tracked, which decreases the risk of unsolicited use of the information without it being identified as such.

### BRIEF DESCRIPTION OF THE DRAWINGS

The invention, together with further objects and advantages thereof, may best be understood by reference to the following description taken in conjunction with the accompanying drawings, wherein:

FIG. 1 is a schematic of a communication arrangement for use in the digital communication system and method in accordance with the invention.

FIG. 2 is a table with examples of parameters of the individual's personal information

FIG. 3 is an example of segmentation of the personal information into sub-categories

FIG. 4 is a schematic of an exemplifying architecture of an information collection and distribution system in accordance with the invention.

FIG. 5 is an example of categorization of the types of individuals that direct marketing agencies utilize.

FIG. 6 is a further schematic example of an opt-in push advertising service in accordance with the invention.

FIG. 7 is a further schematic example of the databases set-up of an information collection and distribution system in accordance with the invention.

### DETAILED DESCRIPTION OF THE INVENTION

The following embodiments are exemplary. Although the specification may refer to “an”, “one”, or “some” embodiment(s) in several locations, this does not necessarily mean that each such reference is to the same embodiment(s), or that the feature only applies to a single embodiment.

The present invention is applicable to any user mobile device, server and/or to any communication system or any combination of different communication systems that can identify users and/or devices by identifiers on units, and/or allocated for the units and/or on the basis of information about the units. The communication system may be a fixed communication system or a wireless communication system or a communication system utilizing both fixed networks and wireless networks. The protocols used, the specifications of communication systems, servers and user terminals, especially in wireless communication, develop rapidly. Such development may require extra changes to the invention. Therefore, all words and expressions should be interpreted broadly and they are intended to illustrate, not to restrict, the invention.

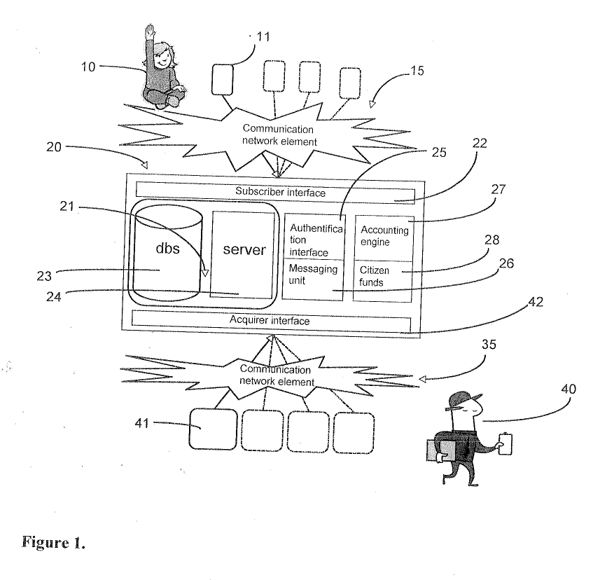

In the following, different embodiments of the invention will be described using mobile phone technology as an example without restricting the invention thereto. A general architecture of a data collection and distribution system 20 capable of providing a more efficient and higher quality digital communication is illustrated in FIG. 1.

FIG. 1 shows how the data collection and distribution system 20 has a data storage unit 21, or more generally data storage means, and a user interface 22, or more generally, user interface means, accessible by an individual or member 10, as referred to herein as a member control panel interface. A member may be considered as an individual or entity who has agreed to participate in the method and system in accordance with the invention. The member 10 is able to access their section of the data storage unit 21 and enter personal information via a communication network element 15, such as the Internet or cellular network using a member device 11, such as a mobile phone, PDA (personal digital assistant), laptop, other wireless device and/or a desktop computer. Data storage unit 21 has at least one database (dbs) 23 and at least one server 24, which are regularly backed-up and have a high level of data security, for example, with one or more passwords and required codes for preventing the data storage unit 21 from being accessed by unauthorized individuals or hacked into.

The member 10 will register and/or set up an account for their first visit to the data storage unit 21, i.e., their first time interacting with the data storage unit 21. The account includes permissions and/or preferences, which are outlined further below. The member 10 also answers a list of questions through, for example, ticking boxes, dragging and dropping icons, and/or simply by writing answers in designated answer fields. By answering these questions, the member 10 is able to build one or more profiles on the system 20. Additional information of the member 10 may also be provided and captured allowing for a highly specific tailoring of the member's profile. This allows the database 23 of member profiles to be dynamic and built in the system 20 so that it contains highly detailed information on the members 10 and also what parts of this information can be shared with others. The administrator of the system 20 is then able to generate profiles of all the members 10 on the system in order to generate a storage data list 30, which can include one or more members 10 with similar profiles or areas of interest depending on what is required for different digital communication campaigns. These data lists 30 are provided and offered to third parties who build and run digital communication campaigns, such as direct advertisements, market research, brand awareness, event and customer satisfaction programs.

Information of the digital communication campaigns may further be feedback to the data system 20 and linked in with the appropriate members 10. One way of allowing the feedback is to track and log the activities of the members on different campaigns and link this information to the specific members. There might also be situations where intrinsic information can be learned from the large pool of members 10, and their behavior or answers on previous communications allows the system to learn from different members 10. It may also be the case where specific questions may be sent to the member 10 to fill in any missing information that would allow for better delivery or quality of digital communication. This feedback loop further assists in getting a targeted profile list 30 of the members 10 dependent on responsiveness, type of responses, specific answers and other information.

Each individual member 10 is able to control their personal information in a much better way than what has previously been possible when third party list brokers have sold individuals information multiple times without the individual member knowing about it. In an exemplifying embodiment of the invention, each member 10 must give permission to the system 20 in order to allow the system to share part of or all of the provided member information with a third party. In some embodiments, it is possible that part of the personal information is made available to some third parties but not others depending on what is designated in the members' preference of what information is to be shared, these preferences preferably being provided by the member themselves.

A data client 40 is then able to securely log onto the system 20 via a communication network element 35, such as the Internet or a cellular network, using a data client device 41 and access a user interface 42 for the client, i.e., client user interface. Through this client user interface 42, it is possible for the data client 41 to access the personal information that the member 10 has made accessible on the data storage unit 21 for third parties such as the data client 41.

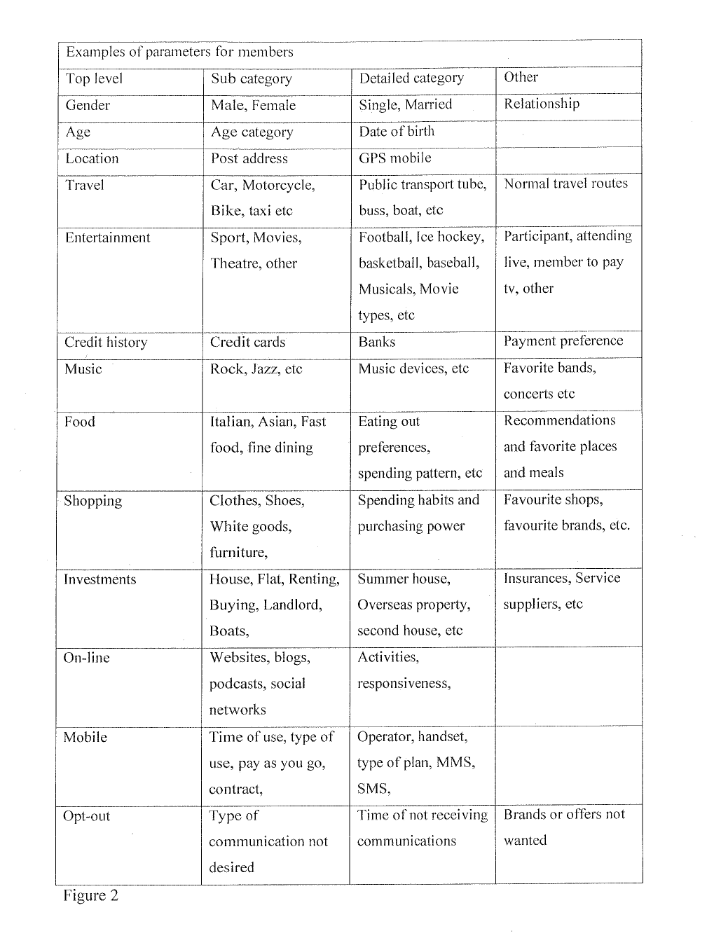

FIG. 2 shows an example of parameters used to build a data list 30, which parameters are linked to specific details and preferences of the different members 10. Examples of the parameters relevant to the digital communication campaigns include, but are not limited to, for example, age, gender, location, address, interests, entertainment, music, food, hobbies, profession, education, activities outside of work, mobile device, availability times for receiving digital communications, preferred networks online, network carriers, travel habits, friends, family, mode of transport and many others.

It has further been seen that the quality of the personal information is improved by segmenting the parameters used to build the data list 30 into larger groups such as i) life preferences, which includes hobbies, social networks, blogging, use of twitter, and other interests like fashion, travel, sport and entertainment; ii) Media channel, which includes the type of communication that is preferred, e.g., SMS, MMS, IM, e-mail, postal mail and any other channel considered; iii) Regularity of communication, which includes dates, days, times and frequency of interaction that the member 10 prefers; and iv) Age, gender and geography, which includes information that can be verified by entering some personal identification or non-verified. By using these or similar segments, it is possible to capture enough information about the member to allow any missing information to be inferred. This so-called “inferred insight” includes information from the members' activities that is not explicitly stated. Examples of such inferred insights could be derived through records of interactive behavior, such as browsing, messaging or buying.

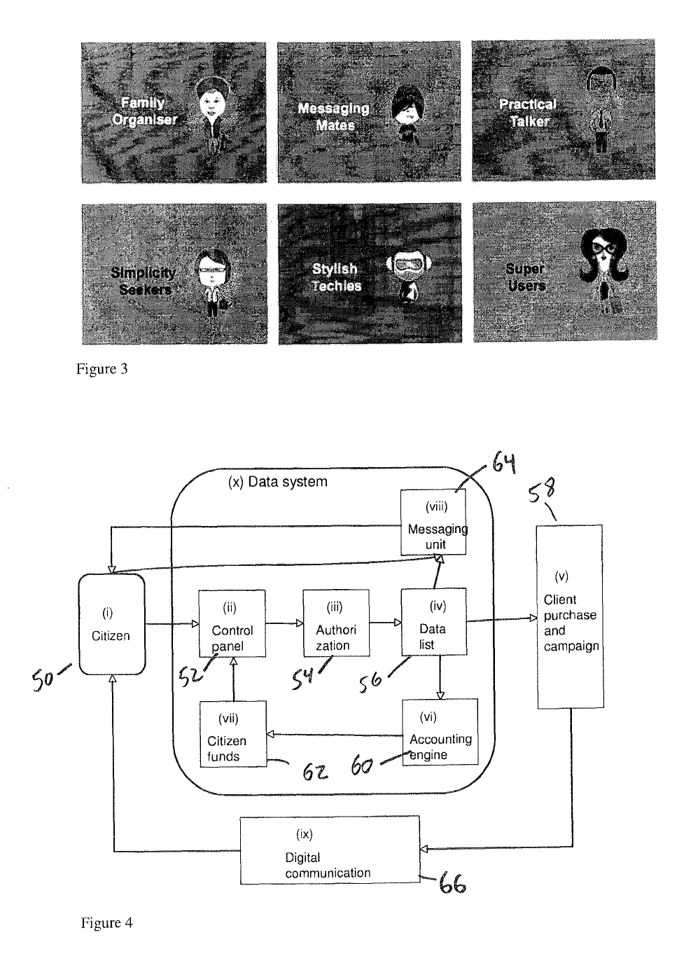

FIG. 3 shows a preferred segmentation of members used to improve the targeting and quality of the data list 30 and hence the digital communication to the members. The segments include: a) Family organizer, b) Simplicity seekers, c) Messaging mate, d) Stylish techies, e) Practical talker, and f) Super users. The family organizer is often the individual constantly on the move and organizing the activities of the family. This could include looking after children, household, family finances, grocery shopping and holidays. The simplicity seeker will have some specific needs and requirements that relate to their interests. The simplicity seeker will adopt new technology if it is easily accessible and digital communications if they are highly relevant, as in the described invention. Messaging mate falls into the category of a generation of users who send very large number of SMS, MMS or IM messages every month. Market feedback shows that they will send and receive in the order of about 2,000 messages per month, and this number is constantly increasing. It further shows the importance of the need to make any digital communication highly relevant and tailored to the member's personal interests and profile. Stylish techies also utilize their mobile device in a much broader sense with high levels of Internet access through their mobile device and social networking with their peers. Digital communications have shown that the practical talker will be interested in information that relates to their daily needs for work, transport and financial planning. Finally, the super user is highly dependent on their mobile device and uses it for organizing travel, work, accessing the Internet, through specific applications, and many other uses.

Each member can be in one or more of the above-described segments. As the data system 20 allows for multiple profiles and/or different permissions and preferences to be entered by the member, e.g., different interests and availability to receive digital communications during and after work hours, the flexibility of the data system 20 allows for the virtually unmatched and unparalleled ability to improve the delivery efficiency and quality of the delivery of digital communications, because it holds the relevant mobile device and personal information needed to optimize such communications. As presently known, this has not been possible in the past, as a notification message has not been sent to the member and there was no added benefit of an incentive for the member to provide the required information.

The client user interface further allows for highly targeted segmentation based on the previously described categories of users, but can also select a mixed group of member traits and selected parameters covering a cross section of these segments. It is further possible to tailor the member group based on the inferred behavior learned and generated by the system. Also, member preferences of communication media, mobile device sophistication, and availability of receiving the communications can be used to improve the segmentation for the client.

In one embodiment, the client is able to select, using an interface to the data system 20 or search engine, a range of preference settings based on traditional direct marketing parameters, such as gender, age, location, interests, preferences and existing member segmentation. However, as the provided details and information from the member 10 are very detailed, selection criteria could also include parameters, such as hours during the day the individual is allowing for reception of information, type of mobile device used by the member and, for example, a travel pattern to and from work. Each parameter of personal information provided by the member 10 can further be assigned with a unique identifier allowing it to be tagged and tracked if ever used and therefore always linked to the appropriate member 10. This feedback of when the personal information of the member 10 is used allows for a highly responsive system and further increases the transmission efficiency of the digital communication provided by the client. Since the member is able to see when their information is used, it further improves the security of the system. If a member is getting digital communications they are not interested in, they are able to amend their profile on the system thereby limiting the communications that are considered to be spam or less relevant information.

FIG. 4 describes how the personal information is used and distributed in the delivery of the digital communication in accordance with the invention. The described steps of the data system may be performed by a processor, non-transitory computer-readable media including one or more computer programs and one or more data storage devices. In addition, communication devices may be coupled to the data system to enable communications with member devices and client devices via a communications network.

Referring then to FIG. 4, at 50, the member 10 enters information in the system 20 using the member's mobile device 11, or other input means. At 52, the member control panel interface 22 adds a secure environment for the personal information to be added to the system 20. The member control panel interface 22 may be implemented as software and/or hardware of the data system, e.g., as a processor running a computer program. At 54, personal information is then given an authorization by the system 20, which is normally in the form of an information authorization processor 25 (also referred to herein as an authentication interface as shown in FIG. 1, and that may also include a software component). The information authorization processor 25 runs a range of rule checks on the provided information and flags any irregularities to the member 10 and/or system administrator, via the member's device (e.g., visual, audible or both). This authorization is performed in real time as the information is entered in the system 20 but can also be performed at a later stage, e.g., at predefined intervals.

Information from the member 10 is then uniquely tagged using an identifier such as a numerical, image, code, password descriptor. In some instances, the identifier may be encrypted into the personal information so that it cannot easily be removed. This tagging feature may be performed by a processor in the data system in conjunction with one or more computer programs run by the processor.

It is possible for the administrator of the data system 20 to perform an audit of any digital communications received by each member 10 to verify that the personal information has not been utilized in any different way than agreed with the data client 40 using the data list 30. This audit may be enabled by the administrator accesses a computer that connects to the data system 20 and running a computer program.

It is also possible that the data list 30 has a time limitation on when it can be used or by how many times it can be used by the data client 40. This would be controlled through a software add-on provided with the data list 30 and/or through the desktop/mobile device application used for accessing the information.

At 56, personal information about the members 10 is provided in data lists 30 through the client user interface 42 for any third party looking to utilize the information. The data list 30 is only based on the permissions or authorizations given by the member 10. The data list 30 can be generated by the administrator of the system 20 and/or by the data client 42 selecting segments and/or parameters they would like to see in the data list 30 using the client user interface 42.

At 58, the personal information is then bought and accessed through the client user interface 42, or otherwise provided to the data client 42 upon predetermined conditions, such as monetary, time-based or otherwise. A monetary transaction takes place between the data client 40 and the system 20, which transaction can be automated if the client 40 is a frequent user of the system 20 and has an account to access information about the members 10. This payment can be through traditional electronic payment setups, like credit card payments through the Internet, direct debit, and/or by passing on the cost of the purchase to the cellular operators invoice to the client if performed through a mobile device.

At 60, an accounting engine 27 within the system 20 (see also FIG. 1) allocates a percentage of the transaction cost, which transaction cost relates to the data list 30 being provided to the data client 40, to those members 10 whose information is in the data list 30. This back payment percentage, which makes up the member funds, is preferable in the range of from about 0.5% to about 75%, more preferably from about 1% to about 50% and most preferably from about 3% to about 30% of the transaction cost divided by the number of members in the data list 30. There is also the possibility of having a greater allocation of the allocated back payment for those members who have, for example, entered most information into the system (in absolute or relative terms to other members), given more permissions to use their information and/or are deemed to be more responsive to prior digital communications through redeeming vouchers, purchasing products or services, or the like (either relative to other members or in absolute terms).

A computer program may reside in the data system and perform the above functions. This computer program may include or provide the accounting engine. Thus, the computer system would allocate a percentage of benefit obtained by inclusion of the personal information of a member in a generated data list to the member, and notify the member of their allocated percentage of benefit, e.g., in a notification message provided by the messaging unit at 64, discussed below. Further, the computer program may monitor responses by each member to digital communications and adjust the percentage of benefit allocated to each member based in part on a history of their responses to digital communications. Additionally or alternatively, the computer program may assess a quantity of personal information provided by each member in absolute or relative terms and adjust the percentage of benefit allocated to each member based in part on the quantity of personal information provided by each member. Additionally or alternatively, the computer program may assess a degree to which each member authorizes use of their personal information and adjust the percentage of benefit allocated to each member based in part on the degree to which each member has authorized use of their personal information.

At 62, members funds are then transferred to a member fund database 28 (also referred to as citizen funds herein, see also FIG. 1), which preferably is part of the system 20, but could also be an external fund managing provider, such as an escrow setup, linked to the system 20 through known e-commerce processes. The member funds are preferably shown on the members' profiles in the system 20 and then available to be drawn down from the escrow setup. The member funds can further be automatically transferred to a personal bank account or to, e.g., a mobile phone account giving free credits for voice, Internet and messages (SMS, MMS, IM).

At 64, as the data client 40 accesses the data list 30, a notification message system or message unit 26 generates and sends a notification message to the member 10. This allows the member to monitor and track when their personal information has been used and also preferably by whom, as the notification message may include a broad client description, possibly without giving full identification thereof. The message is preferably in the form of a notification or counter on the member profile in the system 20, but can also be in the form of an e-mail or message (SMS) to the member outside of the system 20. In the latter case, it will allow for a feedback option in the event that the member is not willing to receive digital communications. Any such feedback updates would then be passed back to the data list client allowing for a better delivery of digital communications. Reasons for not wanting digital communications could be, e.g., that the member is traveling, out of their normal working hours, or simply too busy with other tasks. As such, included in the notification message may be a feedback option, e.g., pressing a button, for the member to indicate a partial or full opt-out to any received or about to be received digital communication.

Accordingly, the notification message may be in the form of or include an accumulative counter on the user profile of the member. This allows the member to be continually notified and monitor how often their personal information has been sold and when they could be expecting to be part of any digital communications (a future communication). Through this feature, it is possible for the member to identify any unsolicited use of their information in digital communications. Moreover, the processor unit may be arranged to cause the counter to trigger directing a secondary notification message to the member device once it passes a predetermined level (e.g., one set by the member). The secondary notification may be a message selected from a group consisting of an SMS message to a mobile device, an MMS message to a mobile device or an e-mail message to a mobile device.

Furthermore, by providing the secondary notification message in a format such as SMS, MMS or e-mail to a mobile device, it is possible for the individual to keep updated on the utilization of their personal information, limiting the fraudulent use.

In one embodiment, feedback on a level of utilization of the personal information, e.g., the number of clients using the personal information, is included in the notification message. A display ranking of the members is generated by a processor associated with the data storage unit and then each client can thereafter access the display ranking or a derivative thereof to identify more responsive members. The display ranking is managed by the processor or operator of the system such that a higher level of successful utilization, i.e., responses by a member, increases the display ranking of the member's personal information thereby causing greater future utilization by subsequent clients. Thus, an advantage of the invention is achieved in that members responding to advertisements are deemed more likely to receive additional advertisements thereby increasing their value to the clients and the potential for rewards (discussed below).

In another embodiment, the data client 40 only gets access to selected information about each member's behavior and interests. Other information, which maybe information that is highly relevant to the member such as address, name, and data of birth, is intentionally not disclosed to the data client 40. However, this highly relevant information could be utilized by the system 20 which is connected to the communication network element 35 allowing for the administrator of the system 20 to send out the digital communication so called campaign.

At 66, the data client 40 then uses the data list 30 directly or indirectly to plan and execute a digital communication campaign. This campaign may be normally, e.g., a direct marketing campaign, event information distribution, clinical trial of new chemical entities or research projects. There is certain information on the data list 30 that allows for the digital communication to be delivered in high quality and through the right channels, preventing overload of the selected communication network element. Typically, the digital communication will be in the form of a mobile message (SMS, MMS or IM) through a cellular network. Sometimes, the digital communication will have questions and/or allow for answers. In such a case, the unique member can further be tracked by tailoring the message response number.

In another embodiment of the present invention, there is a credited reward that is automatically allocated to the member once the personal information is utilized by the client, and may be included in the notification message sent to the member. This allows the member to be given incentives when their information is used. This also contributes to the member making sure that any information is updated, and accurate, and thus provided to the data client 40 with any specific, relevant information needed for successful delivery of the digital communication resulting in improved efficiency and quality compared to existing methods used today.

Further, the credit reward may be a percentage royalty to the member of the direct digital communication cost, thereby serving as an incentive to respond and interact with the digital communication. It is, in addition, possible to access and redeem the credit reward through a subscription device. This allows for electronic transfers and the accumulation of multiple streams of credit rewards without the needed interaction with the system on behalf of the member. Through the use of the properties of the member's mobile device, on/off, location using, e.g., GPS, pattern of use and the like, it is possible to automate any behavior-linked activities of the system.

Accordingly, a processor of the system can be arranged to generate a variable reward based on each members response to the notification messages. For example, the reward may be selected based on response rate of the member to the notification message, frequency of given responses to notification messages, and/or purchases made of goods and services relating to the digital communication. The reward or reward credit may be determined as a percentage of a cost of the digital communication sent to the member, to allow the system operator to make a profit yet still compensate the member.

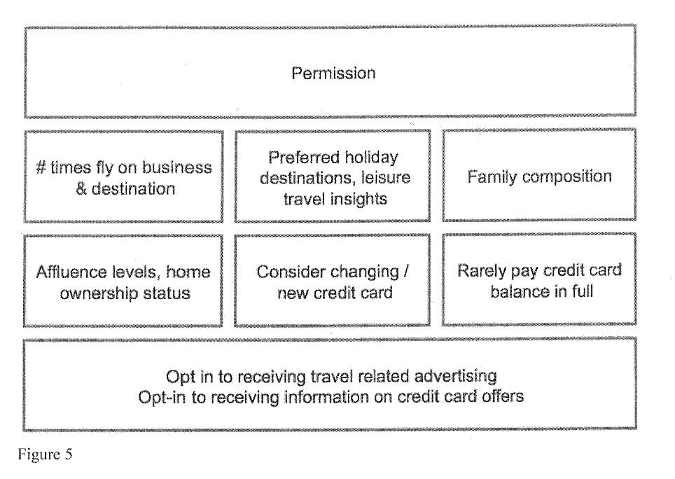

An example of segments and parameters that may be utilized in accordance with the invention is shown in FIG. 5 where the data list 30 is used to provide information in the segments shown. The segments may be selected by a company providing financial services, such as a credit card company or frequent flyer club, to tailor a digital communication. This information would only be information that the member 10 has given permission to distribute or share that would be used to build the target group profile. Depending on the target group in the data list 30, a preferred channel could be selected, such as SMS or MMS, along with the time and/or date of distribution.

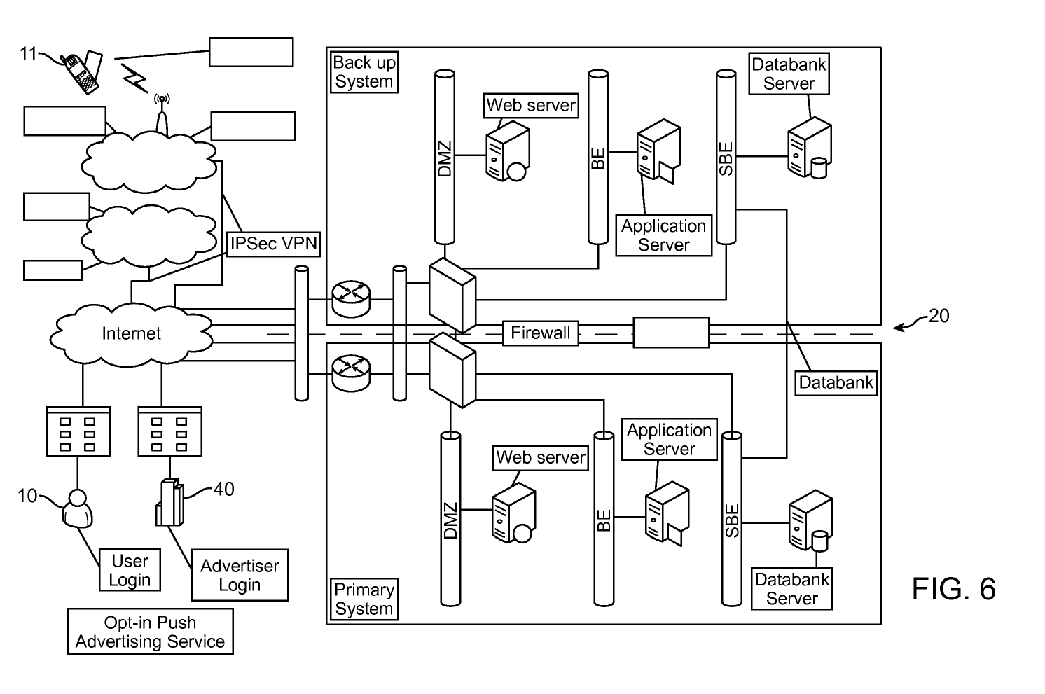

FIG. 6 describes how the set-up is optimized for one embodiment of the invention. More specifically, FIG. 6 shows how a member 10, a so-called Enduser, has a login which is done in a secure manner through a webpage on the Internet and/or mobile Internet to the system 20. Similarly, the data client 40, a so-called Agency/Advertiser, has a secure login also connected to the Internet and/or mobile Internet to access the system 20. The system 20 has a primary system, a so-called Primary System, which has firewalls and a set-up of the Webserver (DMZ), Application server (BE) and Databank server (SBE). As the content held on the system 20 is highly sensitive and very comprehensive covering all aspects of the member 10, it is preferred, but not required, to provide at least one backup system. There are preferably redundancies and a firewall system between the primary and each backup system, even with them being preferably separated physically (which is often the case with a backup system). The backup system preferably has firewalls separating the backup Webserver (DMZ), Application Server (BE), and Databank Server from each other but also from the primary system 20. There may be a mirroring of the Databank Servers in the primary and backup parts of the setup. The system 20 is connected to the Internet and communication network element via ports and switches. Further, there are typically IPSec and VPN connections setup via the communication network element to the member device 11, e.g., a mobile or PDA.

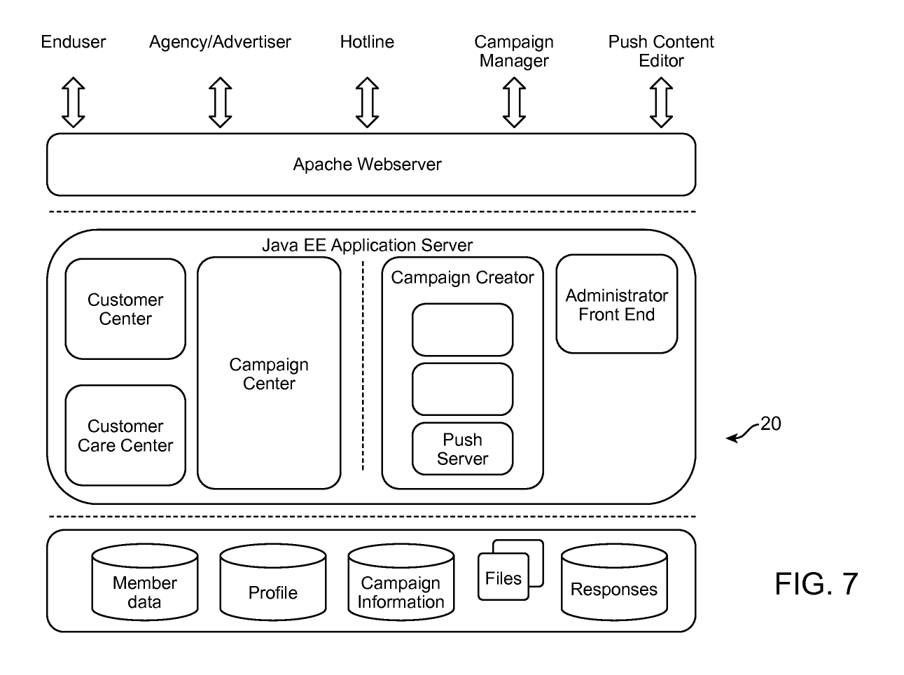

FIG. 7 shows a more detailed breakdown of how the system 20 can be set-up in one embodiment of the invention. At the data management level, there are several areas which holds information, such as basic member data (Stammdaten), profile data (Profile), campaign information (Kampagnen), different files required (Files) and Responses (Responds) logged historically and available for data mining.

The Java EE Application server has two parts; a first part that has a Customer Center, a Customer Care Center and a Campaign Center, and a second part that has a Campaign Creator, which includes a push server among other servers and components, and an Administration Front End.

An Apache Web Server may be used as an interface between the Java EE Application Server and external access parts, such as the Enduser (member), Agency/Advertiser (Client), Hotline, Campaign manager (Kampagnenmanager), as well as the Push Content Editor.

Another feature of the system 20 is that there is an automated process of registering every member on the unwanted Advertising lists and registries in different markets. In many markets, e.g., Germany, Switzerland, Austria national markets, there are codes of conduct for any direct marketing operations. These codes of conduct are further complemented by, for example, the Robinson List in Germany (https://www.robinsonliste.de/) and Belgium (http://www.robinsonlist.be/index_fr.htm), while it is the TPS in Great Britain (http://www.tpsonline.org.uk/tps/) who control the registry of opting out of receiving advertisement. The system according to the invention takes on the role of these opting out services with the added advantage of selectively allowing for desired or permitted advertisements to be received. It allows for all types of, e.g., direct marketing and surveys to be created, managed, and executed from one system, allowing for efficiency savings on loading of the communication network element. There is a decreased risk of identity theft as the member's information and data is kept by one party and the opting-in also resulting in opting-out of other electronic communication, which other “spam” communication is becoming a serious nuisance for mobile phone users. It also allows the clients to get a much improved traceability and measurable campaign run.

The functions described above may be implemented on typical computer and communications hardware and software. Further, the functions may be implemented by one or more computer programs interacting with such hardware, e.g., a computer program in the data system shown in FIG. 4.

In the context of this specification, computer-readable medium, or more specifically, non-transitory computer-readable medium, could be any means that can contain, store, communicate, propagate or transmit a program for use by or in connection with the method, system, apparatus or device. The computer-readable medium can be, but is not limited to (not an exhaustive list), electronic, magnetic, optical, electromagnetic, infrared, or semi-conductor propagation medium. The medium can also be (not an exhaustive list) an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM). The medium can also be paper or other suitable medium upon which a program is printed, as the program can be electronically captured, via for example, optical scanning of the paper or other medium, then compiled, interpreted, or otherwise processed in a suitable manner, if necessary, and then stored in a computer memory. Also, a computer program or data may be transferred to another computer-readable medium by any suitable process such as by scanning the computer-readable medium.

It will be obvious to a person skilled in the art that, as the technology advances, the inventive concept can be implemented in various ways. The invention and its embodiments are not limited to the examples described above but may vary within the scope of the claims.

1. A method for managing information from at least one member in a data storage unit to be used for digital communication, the method comprising:
enabling each of the at least one member to access the data storage unit using a member device and enter personal information into the data storage unit;
associating, using a processor, at least one part of each member's personal information with an unique identifier that enables tracking of use of the member's personal information;
enabling each member to interface with the data storage unit using the member device and select what personal information is allowed to be distributed by the data storage unit;
enabling personal information about the at least one member to be accessed by a client through a client interface via a communication network element; and
sending a notification message to the at least one member when personal information about that member from the data storage unit is made available to the client or utilized by the client to send a digital communication to the member device.

2. The method of claim 1, wherein the personal information includes information about a plurality of parameters relating to delivery of the digital communication to the member device.

3. The method of claim 2, further comprising selecting the parameters from a group consisting of a model of the member device, a make of the member device, receipt times of the digital communication by the member at their member device, a location of the member device, one or more preferences of the member relating to receipt of digital communications and availability of the member to receive the digital communication at their member device.

4. The method of claim 2, wherein the step of enabling each member to interface with the data storage unit using the member device and select what personal information is allowed to be distributed by the data storage unit comprises enabling the member to select what parameters to distribute and what parameters not to distribute.

5. The method of claim 2, wherein the step of enabling each member to interface with the data storage unit using the member device and select what personal information is allowed to be distributed by the data storage unit comprises enabling the member to select a respective set of parameters to distribute to each of a plurality of different clients.

6. The method of claim 1, further comprising:
including in the notification message, feedback on a level of utilization of the personal information; and
generating a display ranking of the at least one member;
enabling each client to access the display ranking or a derivative thereof; and
managing the display ranking such that a higher level of successful utilization increases the display ranking of the member's personal information thereby causing greater future utilization by clients.

7. The method of claim 1, further comprising:
generating a variable reward based on each members response to the notification messages; and
determining the reward based on at least one of the following parameters: response rate of the member to the notification message, frequency of given responses to notification messages, and purchases made by the member of goods and services relating to previously sent digital communication.

8. The method of claim 1, further comprising:
including in the notification message, a reward credit; and
determining the reward credit as a percentage of a cost of the digital communication sent to the at least one member.

9. The method of claim 1, further comprising including in the notification message, a feedback option for the member to indicate a partial or full opt-out to any received or about to be received digital communication.

10. The method of claim 1, further comprising:
including in the notification message, an accumulative counter on a user profile of a member;
forming the counter to trigger a secondary notification message to the member device once it passes a predetermined level.

11. The method of claim 10, wherein the secondary notification is a message selected from a group consisting of an SMS message to a mobile device, an MMS message to a mobile device or an e-mail message to a mobile device.

12. A system for managing information from at least one member in a data storage unit to be used for digital communication, comprising:
a processor arranged to interact with a member device via a communications network and enable each member to enter using the member device, personal information in predefined parameter fields, to update existing information in the fields and access an overall member profile;
a user interface of the data storage unit accessible by a client seeking information about members to enable the client to access available personal information from members using a client device; and
a notification message system that sends a message via a communication network element to the member when their personal information is accessed, the notification message system being arranged to store in the notification message, an amount of credits allocated to the member following use of the member's personal information in the data storage unit.

13. The system of claim 12, wherein the notification message system is arranged to generate the notification message in the form of an SMS message, an MMS message, an e-mail message or an electronic transfer.

14. The system of claim 12, wherein the data storage unit is arranged to provide a tagging and tracking feature linked to the personal information entered by the member allowing the use of the personal information to be tracked in the digital communication network.

15. The system of claim 14, wherein the processor is arranged to enable audit of each member's personal information by identifying a tag linked to the personal information of each member and tracking the tag in communications to the member.

16. The system of claim 12, wherein the user interface is arranged to enable the client to purchase personal information about members, the notification message system being further arranged to send a message via the communication network element to the member when their personal information is purchased.

17. The system of claim 16, wherein the notification message system is further arranged to send the message to the member, when their personal information is purchased, including an identity of the purchaser.

18. The system of claim 12, wherein the notification message system is arranged to increase the number of credits allocated to the member in conjunction with each utilization of the member's personal information from the data storage unit.

19. The system of claim 18, wherein the notification message system is further arranged to base the increase in the number of credits on cost of the digital communication to the member.

20. A computer program embodied on non-transitory computer-readable media and resident in a data system for managing information from at least one member in a data storage unit associated with the data system to be used for digital communication, the computer program being arranged to:
enable each of the at least one member to access the data storage unit using a member device and enter personal information into the data storage unit;
enable each member to interface with the data storage unit using the member device and select what personal information is allowed to be distributed by the data storage unit;
associate at least one part of each member's personal information with an unique tag or identifier that enables tracking of use of the member's personal information;
enable personal information about the at least one member in the data storage unit to be accessed by a client through a client interface via a communication network element; and
send a notification message to the at least one member when personal information about that member from the data storage unit is made available to the client or utilized by the client to send a digital communication.

21. The computer program of claim 20, wherein the computer program is further arranged to:
perform an authentication of personal information entered by each member; and
notify each member or an administrator of the computer program when entered personal information is deemed to be irregular.

22. The computer program of claim 20, wherein the computer program is further arranged to enable tracking of use of personal information of each member in the data storage unit by clients by determining use of the unique tag or identified associated with that member's personal information.

23. The computer program of claim 20, wherein the computer program is further arranged to:
establish a time limit on use by a client of personal information about each member; or
establish a limit on a number of times a client may use personal information about each member.

24. The computer program of claim 20, wherein the computer program is further arranged to:
generate data lists from personal information entered by a plurality of members in the data storage unit based on one or more selected parameters of information about members sought by the client and authorization provided by members to use of their personal information; and
provide to the client a generated data list upon predetermined conditions.

25. The computer program of claim 24, wherein the computer program is further arranged to:
allocate a percentage of benefit obtained by inclusion of the personal information of a member in a generated data list to the member; and
notify the member of their allocated percentage of benefit.

26. The computer program of claim 25, wherein the computer program is further arranged to:
monitor responses by each member to digital communications; and
adjust the percentage of benefit allocated to each member based in part on a history of their responses to digital communications.

27. The computer program of claim 25, wherein the computer program is further arranged to:
assess a quantity of personal information provided by each member in absolute or relative terms; and
adjust the percentage of benefit allocated to each member based in part on the quantity of personal information provided by each member.

28. The computer program of claim 25, wherein the computer program is further arranged to:
assess a degree to which each member authorizes use of their personal information; and
adjust the percentage of benefit allocated to each member based in part on the degree to which each member has authorized use of their personal information.

29. The computer program of claim 25, wherein the computer program is further arranged to manage a database including data about benefits obtained by members by virtue of their authorizing clients to access their personal information.

30. The computer program of claim 20, wherein the computer program is further arranged to include in the notification message an identification of the client using or accessing the member's personal information.

31. The computer program of claim 20, wherein the computer program is further arranged to enable each client to develop a campaign to identified members by enabling the client to select one or more parameters into which the members are segmented and thereby provide the client with a list of members associated with each of the selected parameters.

32. A method for accessing personal information from at least one member from a data storage unit to be used for digital communication, the method comprising:
enabling personal information about the at least one member to be accessed by a client through a client interface and client device;
providing a search engine on a client device to enable the client to search the personal information on the data storage unit to find and select at least one member and request access to the personal information of each selected member from the data storage unit; and
directing, using a communications network, a digital communication in the form of a questionnaire or an advertisement to each selected member based on the provided personal information.

33. The method of claim 32, wherein the personal information includes a plurality of parameters relating to delivery of the digital communication to the members, the step of providing the search engine to enable the client to search the personal information on the data storage unit comprising enabling the client to select specific ones of the parameters to thereby obtain contact information about members having the same selected specific parameter(s).
